(19) United States
(12) Patent Application Publication
(10) Pub. No.: US 2003/0101599 A1
(43) Pub. Date: Jun. 5, 2003

(54) Saber saw with flush cutting capability

(76) Inventor: Edgar L. Swift, Roswell, GA (US)

Correspondence Address: Edgar L. Swift, 1596 Sandpoint Drive, Roswell, GA, 30075, US

(21) Appl. No.: 10/005,630

(22) Filed: Dec. 5, 2001

(51) Int. Cl. B23D 49/10

(52) U.S. Cl. 30/392; 30/277.4

(57) ABSTRACT

This invention discloses a hand-held electric powered flush cutting saber saw that is capable of making flush cuts both up to and along a surface lying in an intersecting perpendicular plane. This is accomplished through means of mounting the saw blade so that its teeth can project beyond the plane of the front of the saw, as well as simultaneously cut in a line that follows a perpendicular plane lying beyond the plane of either side of the saw's housing.

### BACKGROUND—FIELD OF THE INVENTION

This invention relates to hand-held, electric powered saber saws and more particularity to electric powered saber saws that are capable of cutting a workpiece flush up to or flush along the surface in an intersecting perpendicular plane, such as a wall or the inside of a boxed-in area.

### BACKGROUND—DESCRIPTION OF PRIOR ART

For certain applications, the electric powered saber saw was a substantial improvement over the prior art hand saws, because it is more efficient and requires less effort on the part of the user to accomplish a cutting task. The conventional electric powered saber saw usually consists of an electric motor that drives a vertical reciprocating shaft to which a blade is affixed to the lower end. The tool has remained virtually unchanged over the years except for the incorporating of cordless power supplies and some attempts to make the changing of blades more convenient.

Based on my review of the prior art, I have identified one hand-held electric powered saber saw that is capable of cutting up to the intersection of two planes. It is disclosed in U.S. Pat. No. 5,535,520 to Armstrong, dated Jul. 16, 1996. Its shortcoming is that although it is capable of cutting a workpiece on one plane, such as a floor, all the way up to a surface in an intersecting perpendicular plane, such as a wall or boxed-in area, it does not have provisions for cutting flush with that perpendicular plane while cutting along it. This is because the saw blade is located on the plane of the longitudal center of the saw and, therefore, roughly one half the saw's width establishes the limit for how closely it can make a cut parallel to the perpendicular surface. The solution to overcoming this limitation is not incorporated into the design of saber saws of the prior art and is, therefore, assumed to have been nonobvious.

### SUMMARY

In view of the foregoing disadvantage inherent in the design of the prior art cited, my proposed flush cutting saber saw, which will be described subsequently in greater detail, is a new and improved saber saw that is capable of flush cutting up to an intersecting plane, as well as along that plane. Some of the objects and advantages of my proposed flush cutting saber saw are:

### OBJECTS AND ADVANTAGES

(a) To provide an electric powered flush cutting saber saw that can make a flush cut up to an intersecting perpendicular plane;

(b) To provide an electric powered flush cutting saber saw that can make a flush cut along an intersecting perpendicular plane;

(c) To provide a hand-held electric powered flush cutting saber saw that is easy to understand and use;

(d) To provide a low-cost electric powered flush cutting saber saw that can be manufactured by making minimal modifications to existing conventional hand-held electric saber saws;

(e) To provide an electric powered flush cutting saber saw that a manufacturer can market to its existing distribution channels with its existing sales force.

Further objects and advantages will become apparent from a consideration of the ensuing drawings and detailed descriptions of the embodiments of this new hand-held, electric powered flush cutting saber saw.

### DRAWINGS

FIG. 1 is a Left side view of a typical hand-held saber saw from which the present flush cutting saber saw is derived.

FIG. 2 is a front view of the prior art saber saw mentioned in FIG. 1 with its shoe and accompanying bevel guide removed.

FIG. 3 shows a partial front view of the bottom portion of a new blade actuator that will replace the blade actuator of the prior art conventional saber saw shown in FIGS. 1 and 2.

FIG. 4 shows a bottom view of the the new blade actuator mentioned in FIG. 3.

FIG. 5 shows a new universal blade clamp that will be incorporated into the design of the new saw.

FIG. 6 shows a front view of the first embodiment of new sawblades that will be incorporated into the design of the new saw.

FIG. 6A shows a front view of the second embodiment of new saw blades that will be incorporated into the design of the new saw.

FIG. 7 shows the bottom view of a new shoe, with its beveled mounting slot, that will be incorporated into the design of the new saw.

FIG. 7A shows the bottom view of a new shoe and countersunk mounting screws that will be incorporated into the design of the new saw.

FIG. 8 shows a view of the left side of the new saw with its shoe adjusted towards the rear of the present saw.

FIG. 9 shows a view of the front of the new saw with a Left side one-piece saw blade installed.

### REFERENCE NUMERALS IN DRAWINGS (*DENOTES PRIOR ART)

| | |
|---|---|
| 10 | Side View of Prior Art Saber Saw* |
| 12 | Housing of Prior Art Saber Saw * |
| 14 | Power Switch * |
| 16 | Power Cord * |
| 18 | Prior Art Blade Actuator * |
| 20 | Prior Art Blade Clamp * |
| 22 | Blade Clamp Screw * |
| 24 | Prior Art Saw Shoe * |
| 26 | Prior Art Saw Blade* |
| 28 | Prior Art Bevel Guide * |
| 30 | Front View of Prior Art Saw * |
| 32 | New Blade Actuator |
| 34 | Threaded Mounting Holes (2) |
| 36 | Actuator Blade Grooves (2) |
| 38 | New Blade Clamp |
| 40 | Smooth Mounting Holes (2) |
| 42 | Blade Clamp Grooves (2) |
| 44 | RH Blade (1st Embod.) |
| 46 | LH Blade (1st Embod.) |
| 48 | RH Blade Assembly (2nd Embod.) |
| 50 | RH Blade (2nd Embod.) |
| 52 | RH Blade Shank (2nd Embod.) |
| 54 | New LH Blade Assembly |
| 56 | New LH Blade |
| 58 | LH Blade Shank (2nd Embod.) |
| 60 | New Sloe |
| 62 | Shoe Mounting Slot |
| 64 | Shoe Mounting Screws (2) |
| 66 | New Blade Clamp Screws (2) |
| 68 | Left Side View Of New Saw |
| 70 | Front View Of New Saw |
| 72 | Line Plug |

### DESCRIPTIONS OF THE PREFERRED EMBODIMENT

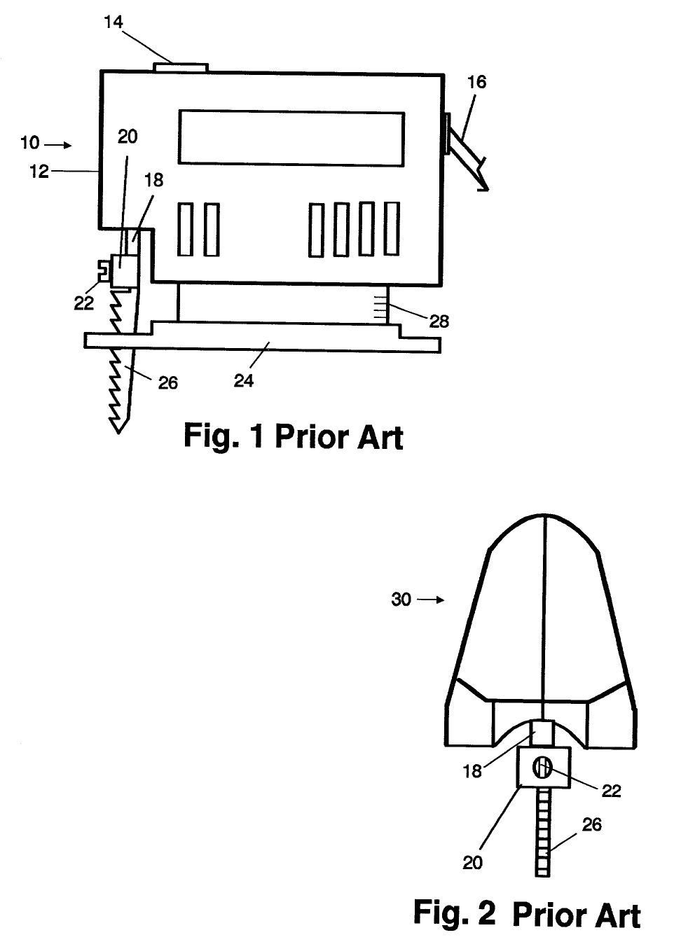

Description—FIG. 1

Ref. 10 shows a typical conventional, hand-held electric powered sabersaw. To provide the viewer with a point of reference, I have drawn this side-view to resemble that of a Black & Decker™, Model 7548 (Hunt Valley, Md., USA), which can be easily modified into the present flush cutting sabersaw. I have chosen to propose using two mounting screws for the shoe 24 instead of one, as will be shown in FIG. 7A. That concept was derived from the Handi Works™ Model HW5552 (England), which can also be easily modified into the present saw. Ref. 12 is a plastic (or other material) housing for the saw. The saw is turned either on or off by a power switch 14, which derives electrical power through a power cord 16. Turning the saw on causes a shaft-like reciprocating blade actuator 18, to reciprocate an attached saw blade 26 vertically in a linear fashion to effect the cutting action. The saw blade 26 is attached to the blade actuator 18 by a blade clamp 20 using a clamp screw 22. A blade bevel guide 28 is rigidly affixed to a saw shoe 24 and, conjunctionally, they provide stablity for the saw while it is cutting, as well as determine the angle of cut relative to the plane occupied by the shoe 24.

Description—FIG. 2

Ref. 30 shows a front view of the conventional hand-held electric powered saber saw shown in FIG. 1. The shoe 24 and its affixed bevel guide 28 have been removed to enable modifications constituted within the present saw. All other reference numbers in this view were described in FIG. 1.

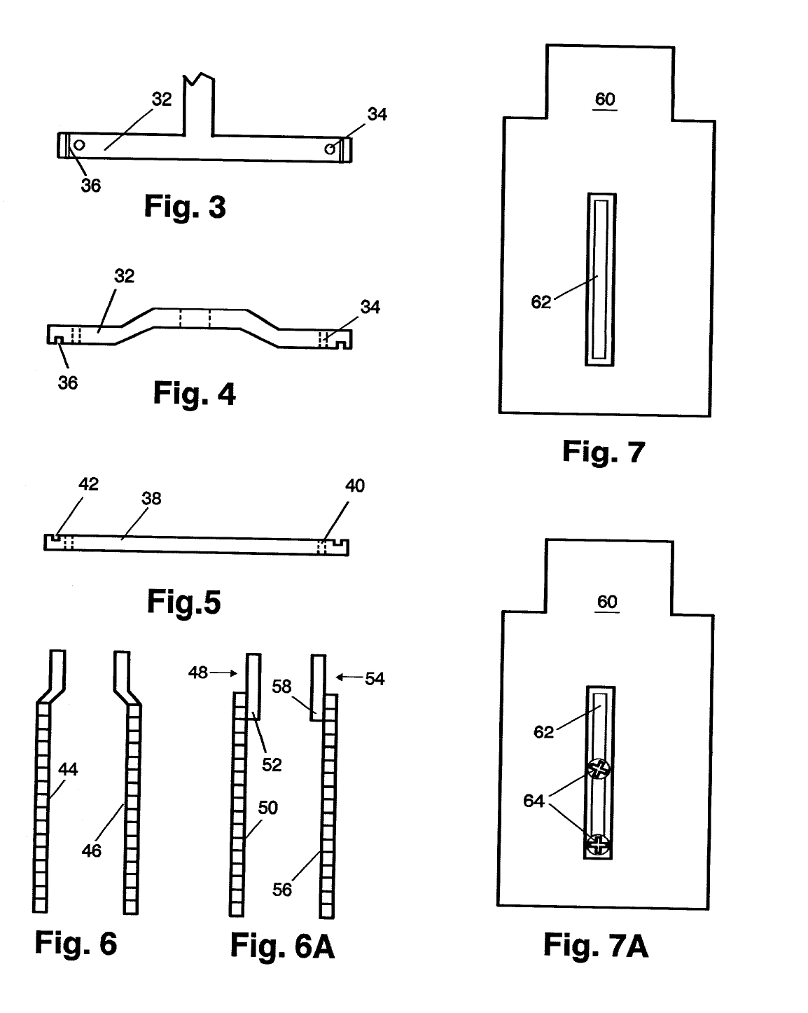

Description—FIG. 3

In order to modify a conventional hand-held saber saw so that it will cut both up to and along a surface in an intersecting perpendicular plane, it was necessary to modify the blade actuator 18 of the prior art saw shown in FIG. 1. FIG. 3 shows a front view of the bottom portion of a new blade actuator 32 that will replace the blade actuator 18 of the prior art. This figure shows the inverted “T” design of the new blade actuator 32, as well as the grooves 36 (one on each end) that will ensure accurate positioning of a new blade, eg., 46 shown in FIG. 6. (Since the new saw uses several different blades, I will arbitrarily use Reference 46 to generally refer to those blades for the sake of simplicity.) When the new blade 46 is attached to either of the far ends of the crossmember of the inverted “T”, they are capable of cutting flush along a surface in an intersecting plane, such as a wall or the inside of a box, which will be described in greater detail later in FIG. 9. The threaded mounting holes 34 will be discussed later in

Description—FIG. 4

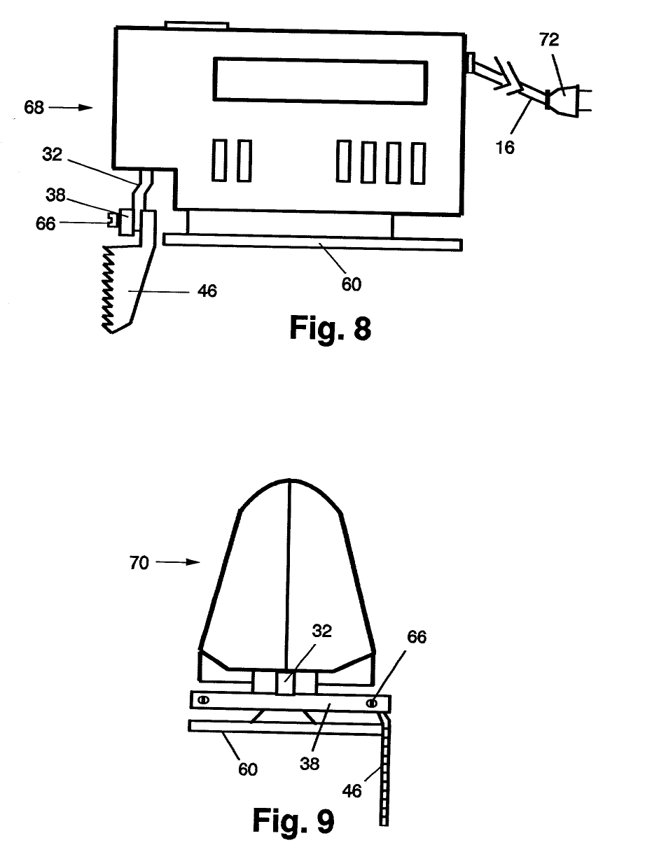

FIG. 4 is a bottom view of the new blade actuator 32 showing how it is formed outwardly towards the front of the saw on each end to allow new blades 46 to be attached to the saw so that the teeth of the blades protrude in a plane beyond the plane of the front of the saw. This allows the present saw to cut all the way up to an intersecting plane and that fact will be pointed out in greater detail in FIG. 8.

Description—FIG. 5

FIG. 5 shows one means of attaching the new saw blades and components 44 thru 58 shown in FIGS. 6 and 6A to the new blade holder 32. A new blade clamp 38 is attached to the blade actuator 32 with machine screws, shown later in FIG. 8, that pass through the smooth mounting holes 40 and into threaded holes 34 of the new blade actuator 32 shown in FIG. 4. Grooves 42, which coincide with the grooves 36 in the blade actuator 32 is incorporated to provide secure lateral positioning for the blade 46.

Description—FIG. 6

FIG. 6 shows one embodiment of the new offset saw blades 44 and 46 that have been jogged at their shanks to allow them to cut flush along the plane of an intersecting perpendicular surface. The jogs in the shanks position the cutting teeth of the blades so that they operate slightly outside the plane of the side of the saw.

Description—FIG. 6A

FIG. 6A shows a second embodiment of offset blade assemblies 48 and 54 for the new saw. They enable the same flush cutting abilities as described in FIG. 6. The off-setting is achieved by welding or otherwise rigidly affixing shanks 52 and 58 to the saw blades 50 and 56. During dynamic operation, the design of these blades may introduce less “flex” into the cutting operation, and their design may introiduce favorable manufacturing considerations as well.

Description—FIG. 7

FIG. 7 is a bottom view of a new shoe 60. It's beveled mounting slot 62 enables its attachment to the base of the present saber saw 68 as will be shown in FIG. 8.

Description—FIG. 7A

FIG. 7A is a bottom view of the new shoe 60 showing how countersunk mounting screws 64 have been inserted into the beveled mounting slot 62. The mounting slot 62 is much longer than the spacing between the two mounting screws 64. This allows the user to slide the shoe 60 towards either the front or back of the saw 68 (FIG. 8) by loosening the mounting screws 64. The significance of this will be discussed in a later section when the operation of the present saw is described.

Description—FIG. 8

Ref. 68 is a left side view of the present saw with the left blade 46 installed. The blade is secured by the blade clamp 38 attached to the new blade actuator 32 using two machine screws 66. The shoe 60 in this view has been moved towards the rear of the saw, as described in FIG. 7A, so that the teeth of the blade 46 are not impeded from cutting all the way up to an intersecting perpendicular plane. Such a view is not shown, however, if the shoe 60 were moved all the way to the front of the saw, the front of the shoe 60 would extend beyond the teeth of the blade 46 and, thus, serve as support for the saw 68 during the initial stages of the cutting process. A line plug 72 has been included in this view in the event that it is chosen for the Official Gazette. Other references in this view have been previously described.

Description—FIG. 9

Ref. 70 is a front view of the present saw with the left side blade 46 installed. This view clearly shows how the inverted “T” design of the new blade actuator 32, in conjunction with the offset shank of the blade 46, enable the saw to cut a workpiece flush along the plane of an intersecting perpendicular surface such as a wall. Other reference numbers in this view have been previously described.

### OPERATION OF THE PREFERRED EMBODIMENT

This operation description is applicable regardless of whether the one-piece jogged blades shown in FIG. 6 are used or the assembled tow-piece saw blades shown in FIG. 6A are used. Should a user be interested only in making cuts that are just nearly flush along the surface in an intersecting perpendicular plane, he or she may also find that using standard, prior art blades, such as shown in FIG. 1, Ref. 26 will suffice.

Therefore, for sake of simplicity, when I specify a blade by using a reference number, those skilled in the art will recognize that other blades described in this specification may or could also apply.

If and when necessary, the user adjusts the position of the shoe 60 (FIG. 8) using the shoe mounting screws 64 (FIG. 7A). When the shoe 60 is adjusted to the front of the saw, initial cuts can be made into the workpiece because the front end of the shoe 60 will provide stability for the saw. The saw's shoe 60 can be left in this position as long as there is no need to cut the workpiece up to the the intersecting plane of a perpendicular surface such as a wall. Should the user need to cut all the way up to that surface, he or she can adjust the position of the shoe 60, using the mounting screws 64, towards the rear of the saw. The desired saw blade, either 26, 44, 46, 48 or 54 is affixed to the blade actuator 32 using the blade clamp 38 secured by the clamp screws 66. The present flush-cutting saber saw may be used in very much the same manner as a conventional saber saw with the additional advantage that it enables cutting a workpiece both up to and along a surface lying in an intersecting perpendicular plane.

### CONCLUSION

Accordingly, the reviewer will see that there are significant advantages of the proposed electric powered flush cutting saber saw over prior art saber saws that are not capable of making completely flush cuts both up to and along surfaces in intersecting perpendicular planes, a capability apparently nonobvious in the prior art. This writer assumes that practically anyone who can use a conventional electric powered saber saw can use the present saw without significant training.

Development, manufacturing and distribution costs are also important, because of the impact that they ultimately have on the price of the product to the consumer. Those costs have been minimized in designing the present saw by using a conventional saber saw, which has already been developed and tested, as the basis for this product. In addition, the present saw can be built and distributed by manufacturers of conventional saber saws that already have the sales force and distribution channels established.

Thus, it will be understood that while the form of the invention herein shown and described constitute preferred embodiments of the invention, it is not intended to illustrate all possible forms of the invention. It will also be understood that the words used throughout this application are words of description rather than words of limitation and that various changes may be made without departing from the spirit and scope of the invention herein disclosed and claimed.

What is claimed is:

1. An electric powered flush cutting saber saw having a housing, an electric motor in the housing, a switchable means for supplying power to the motor, a handle for carrying and operating the saw and a reciprocating blade actuator operably connected to the motor by a means that converts the rotational motion of the motor's shaft to linear motion at the blade.

2. The device of claim 1 wherein it is capable of cutting flush both up to and cutting flush along an intersecting surface such as wall lying in a perpendicular plane.

3. The device of claim 1 wherein a new shoe to stabilize the saw while cutting is attached to the bottom of the saw's housing by suitable means.

4. The device of claim 1 wherein the shoe has a mounting slot with beveled edges to enable the use of flush, countersunk mounting screws.

5. The device of claim 1 wherein the shoe can be adjusted forwardly to provide support for the saw during the initial cutting operation and then adjusted rearwardly to enable the saw to make flush cuts up to a surface lying in an intersecting perpendicular plane.

6. The device of claim 1 wherein it can be developed relatively inexpensively by making minor modifications to an already invented conventional saber saw.

7. The device of claim 1 wherein it can be marketed by a manufacturer of conventional saber saws to its existing distribution channels using its existing sales force with minimal training and channel development costs.

8. The device of claim 1 wherein it can be used by one skilled in the use of a conventional saber saw with minimal training.

9. The device of claim 1 wherein a new reciprocating blade actuator with means for attaching a saw blade so mounted as to enable the blade's teeth to simultaneously project beyond the plane of the front of the saw's housing as well as operate in a plane that is beyond the plane of either side of the saw's housing.

10. The device of claim 9 wherein the reciprocating blade actuator is a one-piece part.

11. The device of claim 9 wherein the reciprocating blade actuator may consist of a plurality of parts.

12. The device of claim 9 wherein the means of attaching the blade to the reciprocating blade actuator is a grooved block clamp affixed to the reciprocating blade actuater by machine screws.

13. The device of claim 1 wherein the sawblade teeth are offset in respect to the longitudal centerline of the blade's mounting shank to enable the saw to cut a workpiece flush along a perpendicular surface such as a wall.

14. The device of claim 13 wherein the shank of the sawblade is a separate part firmly affixed to the sawblade by a suitable means.

15. The device of claim 13 wherein the sawblade and its shank are formed from a one-piece part.

16. The device of claim 13 wherein the saw is capable of cutting nearly flush along the plane of a perpendicular surface by using readily available, conventional non-offset shank blades.
